(19) United States
(12) Patent Application Publication
(10) Pub. No.: US 2007/0251070 A1
(43) Pub. Date: Nov. 1, 2007

(54) Roller Holder Unit

(76) Inventor: Rene' Amherd, Wollerau (CH)

Correspondence Address: FAY SHARPE LLP, 1100 SUPERIOR AVENUE, SEVENTH FLOOR, CLEVELAND, OH, 44114, US

(21) Appl. No.: 10/579,689

(22) PCT Filed: Nov. 10, 2004
(86) PCT No.: PCT/CH04/00681

§ 371 Date: Mar. 5, 2007

(30) Foreign Application Priority Data
Nov. 20, 2003 (CH) 1981/03

(51) Int. Cl. B23P 19/04

(52) U.S. Cl. 29/237

(57) ABSTRACT

The pressing tool comprises a drive unit (70), a piston cylinder unit (5) with a fork-like receiver (55) and the actual clamping pincer (60). The clamping pincer (60) comprises a T-shaped mounting which is connected to a retaining bolt (54) and a retaining bolt receiver (61) with the fork-like receiver (55). A roller holder unit with a roller holder and two rollers (2) are located in the fork-like receiver (55). The fork-like receiver (55) is part of the piston cylinder unit (5). On actuation of the pressing tool, the piston-cylinder unit (5) is pulled back and by way of this the roller holder with the rollers is moved forwards relative to this towards the clamping pincer (60). The rollers (2) at the same time roll on the clamping jaws (62). The clamping is accomplished. At the same time the clamping pincer (60) is pressed together in that the clamping jaws (62) are pressed apart at the rear by the rollers (2).

The invention relates to a roller holder unit for a pressing tool, according to the preamble of the independent patent claim.

A pressing tool is known from the German patent DE-196'31'019 which comprises a pressing pincer for connecting a tube to a press fitting. The pressing pincer comprises two pivot arms which by way of in each case one bolt are pivotally articulated between two equal T-shaped carrier plates. A piston-cylinder unit is actively connected to the roller holder which comprises two rollers. The pivot arms at one end are provided with a roll surface for bearing on the press cylinder of the pressing tool. At the opposite end they are designed as clamping jaws with press surfaces directed to one another. The articulations for the bolts are located at a distance on the carrier plates. A receiver of a connection bolt for connection to the pressing apparatus is located in the region of the free end of the T-shaped carrier plates. On application of this apparatus, the pressing pincer is pulled to the rear to the pressing tool. At the same time the pivot arms with their roll surfaces slide to the rear along the pressing apparatus. The tensile force is transmitted via the connection bolts onto the T-shaped carrier plates. By way of this the pivot arms pivot about the bearing bolts, and the pressing jaws are moved towards one another and pressed together.

An electrically operated pressing tool is known from the European patent EP-1'103'349, which actuates a hydraulic piston cylinder unit by way of an electrically operated hydraulic pump. This unit is actively connected to a roller holder which comprises two rollers. The clamping jaws are connected via a retaining bolt to a fork-like receiver by way of a T-shaped suspension. The fork-like receiver is part of the piston-cylinder unit. The rollers on the roller holder roll on the clamping jaw of a clamping pincer as soon as the clamping pincer is pulled rearwards by the piston cylinder unit, and thus the clamping is undergone. With this, the clamping pincer is pressed together in that the clamping jaws at the rear are pressed apart by the rollers. With this design the roller holder has the shape of a yoke which is rigidly connected to the piston rod. The roller holder, rollers and roller mounting need to be designed in a very solid manner, since the full pressing force and the actuation force of the piston-cylinder unit when the rollers roll on the clamping jaws needs to be accommodated by the rollers via their mounting and transmitted to the roller holder. This design of the roller holder necessitates a corresponding constructional size and dimensioning of the retaining plates and the rollers, roller bearings and bearing pins. It is accordingly heavy and complicated in its manufacture.

It is the object of the invention to manufacture a roller holder unit which no longer has these disadvantages. It must be simple to manufacture, lightweight and space-saving.

The invention according to the independent claims achieves this object.

One advantage of the invention lies in the fact that the roller holder unit is inexpensive with regard to the material and manufacture.

An additional advantage of the invention is the fact that the new roller mounting may be designed in a practically wear-free manner.

A further advantage of the invention lies in the fact that the rollers may be simply and easily exchanged.

The invention is hereinafter described in combination with the drawings. There are shown in

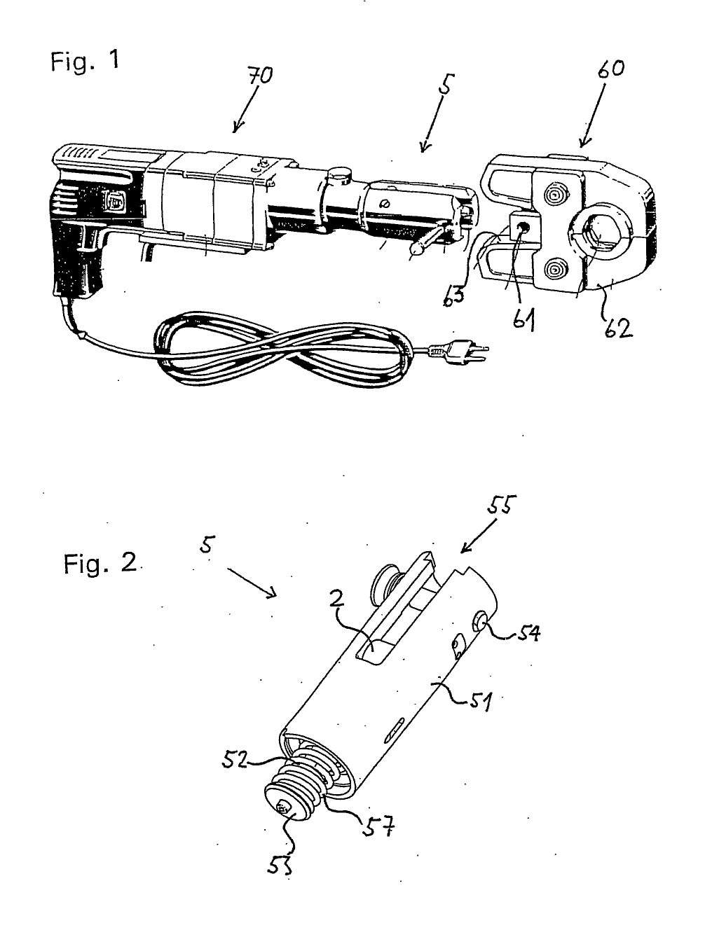

FIG. 1 a view of the pressing pincer;

FIG. 2 a view of the piston-cylinder unit;

FIG. 3 the piston-cylinder unit in section, with the new roller holder;

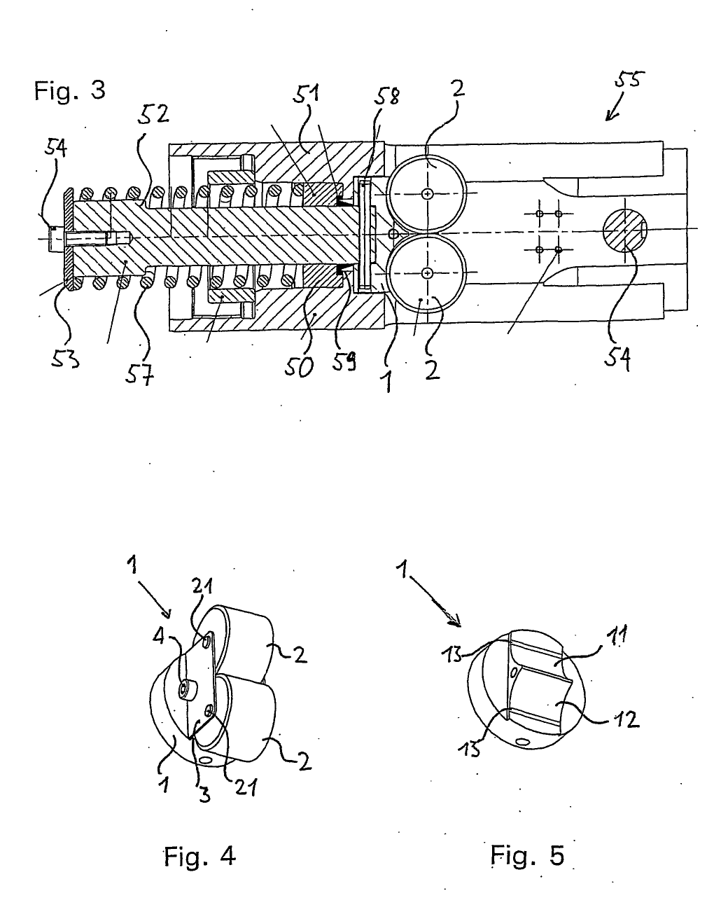

FIG. 4 a view of the new roller holder unit, and

FIG. 5 a view of the pressure bearing block of the new roller holder unit.

A pressing tool according to the state of the art is represented in FIG. 1. It comprises a drive unit 70, a piston-cylinder unit 5 with a fork-like receiver 55 and the actual clamping pincer 60. The clamping pincer 60 is fastened to a T-shape mounting which with a retaining bolt 54 and a retaining bolt receiver 61 is connected to the fork-like receiver 55. A roller holder with two rollers is located in the fork-like receiver 55. The fork-like receiver 55 is part of the piston-cylinder unit 5. The rollers roll on the clamping jaws 62 of a clamping pincer 60 as soon as the piston rod is pushed to the front. With this, the clamping pincer 60 is pressed together in that the clamping jaws 62 at the rear are pressed apart by the rollers. The clamping is then completed.

The piston-cylinder unit 5 forms the connection of the drive unit 70 and the clamping pincer 60. According to FIG. 2, it consists of a cylinder head 51 with a through-bore for accommodating a retaining bolt 54 for fastening the clamping pincer 60. A compression spring 57 is located in the cylinder head, which pushes a piston rod 52 to the front in a rest position. One of the rollers 2 is partly visible in the fork-like receiver 55. On actuating the pressing tool, the piston rod 52 is pushed to the front. The cylinder head 51 remains stationary by which means the rollers 2 are moved relatively to the front within the fork-like receiver 55. The pressing jaws 62 project somewhat into the fork-like receiver 55 and with their roller flanks 63 bear on the rollers 2 on the outside. Thus the rollers 2 run on the pressing jaws 62 along the roller flanks 63 and press these outwards. The pressing is carried out in the clamping pincer 60.

More details of the piston-cylinder unit 5 are evident from FIG. 3 shown in section, in combination with the roller holder unit. The piston rod 52 at one side projects into the cylinder head 51. It is biased by way of a compression spring 57. The compression spring 57 encompasses the piston rod 52 and at one end abuts a spring washer 53 and at the other end a seal retaining ring 50. The spring washer 53 is fastened to the piston rod 52 with a screw. A scraper ring 59 is arranged between the seal retaining ring 50 and the cylinder head 51, and this is passed through by the piston rod 52. The roller holder unit is fastened at the head-side end of the piston rod 52. It projects from the cylinder head 51 into the region of the fork-like receiver 55, and specifically such that two rollers 2 are partly located in the opening of the fork. A bearing block 1 of the roller holder unit is fixed on the piston rod 52 by way of a clamping pin 58. If then on actuation of the pressing tool, the piston rod 52 is pushed to the front, wherein the cylinder head 51 and the clamping pincer 60 remain stationary, then the roller holder unit is moved within the fork-like receiver 55 towards the retaining bolt 54 and thus towards the clamping jaws 62. The rollers 2 thus roll along the roller flanks 63 of the clamping jaws 62 and press these apart. As soon as the pressing has been completed the piston rod 52 is moved back into the rest position by the compression spring 57. Thus the roller holder unit also moves back into the rest position just outside the cylinder head 51.

The roller holder unit is shown in a view in FIG. 4. It consists of a bearing block 1 which corresponds to a cylindrical recess in the cylinder head 51 on its outer side at the end-face. At least one, but advantageously two parallel retainer plates 3 are present on the bearing block 1 in a perpendicular manner. They are fastened to the bearing block 1 by way of screws 4. Two rollers 2 are present distanced to one another on the retaining plate 3 or between the two retaining plates 3. The rollers 2 are arranged such that they contact one another at a straight line on their periphery. They are therefore mutually supported on one another and roll on one another. They are secured from falling out by way of securing pins 21. Since the securing pins 21 do not need to accommodate and bearing forces, they are lightly dimensioned and per se require no extra mounting for the rollers 2 on the securing pins 21. One may even realize an embodiment without through-bores of the rollers 2. The geometric arrangement and design of the clamping jaws may prevent the rollers 2 from falling out. The securing function when permitting a rotation movement of the rollers 2 is also ensured. If the inner diameter of the rollers is somewhat larger than the diameter of the securing pins 21 and thus much play is present, then suitable surfaces on the securing pin 21 and on the through bores of the rollers 2 are sufficient. Thus for example steel rollers with securing pins 21 of bronze may be used which here ensures a permanent self-lubrication. The mounting of the rollers 2 in the roller holder unit is significantly new. One the one hand the rollers 2 as already described are mutually supported on one another and on the other hand are supported against suitable sliding bearing surfaces 11, 12 on the bearing block 1. The main loading of the rollers 2 on actuating the pressing tool on the one hand is produced by the pressing-apart of the rolling flanks 63 of the clamping jaws 62. The direction of this loading is effected via the roller surface in a straight line through the center of the rollers 2 onto the respective other roller. The rollers 2 are thus mutually supported on one another. This means that this loading need not be accommodated nor transmitted by the securing pins 21 and the retaining plates 3. A second type of loading of the rollers is effected by the relative movement of the piston rod 52 and thus of the bearing bock 1. This loading is always effected perpendicularly to the bearing block 1. For this purpose the bearing block 1 is provided with the sliding bearing surfaces 11, 12. The sliding bearing surfaces 11, 12 correspond to the circumference and the outer diameter of the rollers 2. They are formed into the bearing block 1 as cylinder cut-outs. With this, the deepest location of the inward formation is effected between the periphery, thus the outer edge, of the bearing block 1 and its center. The mentioned forces therefore as a rule are transmitted perpendicularly onto the sliding bearing surfaces 11, 12. So that the sliding friction of the surfaces of the rollers 2 on the sliding bearing surfaces 11, 12 does not become too large and blocks the actuation of the pressing tool, the nature of the surfaces of the rollers 2 and of the sliding bearing surfaces 11, 12 are matched to one another. They may be hardened, sintered or coated. A carbon nitration, a Teflon coating of the sliding bearing surfaces or likewise is suitable. The selection of a ceramic material for the bearing block 1 and rollers 2 of steel with hardened surfaces is also suitable. The selection of other, special material pairings is also conceivable. For example a pairing of chromed steel rollers with a bearing block of nylon-6 may lead to a suitable result. With this one even obtains an additional impact damping without compromising the pressing force. Additionally one may provide a lubrication groove 13 for each sliding bearings surface 11, 12 which may serve for the supply of lubricants as well as for the removal of any worn material which occurs.

From that which has been cited it is evident from that the complete design and arrangement of the roller holder unit with the rollers, their mounting, securing and retaining plates may be designed in a manner which is significantly simpler and more lightweight that previously. The rollers 2 are mutually supported on one another for accommodating the largest forces. Their axis of rotation is not loaded and may be limited to securing the rollers 2 from falling out.

The design may be further simplified by way of manufacturing the bearing block 1 and the sliding bearing surfaces 11, 12 as one piece from the same material. With the use of a suitable material these parts may even be manufactured as one piece together with the retaining plates 3.

### LIST OF REFERENCE NUMERALS

1 bearing block
2 rollers
3 retaining plate
4 retaining plate fixation
5 piston-cylinder unit
11 sliding bearing surface
12 sliding bearing surface
13 lubrication groove
21 securing pin
50 seal retaining ring
51 cylinder head
52 piston rod
53 spring washer
54 washer fastening
55 fork-like receiver
57 compression spring
58 clamping pin
59 scraper ring
60 clamping pincer
61 retaining bolt receiver
62 clamping jaws
63 roll flanks
70 drive unit

1. A roller holder unit with rollers for use with an electrically, electro-hydraulically, or pneumatically operated pressing tool with a piston-cylinder unit with which the clamping jaws are connected to a fork-like receiver by way of a retaining bolt, wherein the rollers roll on the clamping jaws of a clamping pincer whilst the clamping pincer is moved by the piston-cylinder unit, wherein the pressing is accomplished in that the clamping jaws at the rear are pressed apart by the rollers, the roller holder unit comprising:
a bearing block; and,
at least one lateral retaining plate arranged thereon in which two rollers are held secured in a freely rotatable manner, wherein the bearing block is provided with a sliding bearing surface for each roller, which in its shape corresponds to the roll surface and thus to the outer diameter of the roller.

2. A roller holder unit according to claim 1, wherein the rollers are secured on the retaining plate with securing pins and, wherein the securing pins are arranged such that the roller at their outer periphery are rotatable, bearing on one another, in the region between the securing pins.

3. A roller holder unit according to claim 1, wherein the sliding bearing surfaces are mirror-symmetric, wherein the deepest location with respect to the bearing block is located between the periphery of the bearing block and its center.

4. A roller holder unit according to claim 1, wherein the bearing block is fastened on a piston rod of the piston-cylinder unit.

5. A roller holder unit according to claim 4, further including a lubrication groove in the sliding bearing surfaces.

6. A roller holder unit according to claim 4, wherein a surface of the sliding bearing surfaces is coated or hardened so that it has a low friction with respect to the rollers.

7. A roller holder unit according to claim 4, wherein the surface of the rollers is coated or hardened so that it has a low friction with respect to the sliding bearing surfaces.

8. A roller holder unit according to claim 4, further including self-lubricating material pairings provided with the rollers and the sliding bearing surfaces.

9. A roller holder unit according to claim 1, wherein the bearing block and the sliding bearing surfaces are of one piece.

10. A roller holder unit according to claim 1, wherein the bearing block, the sliding bearing surfaces and retaining plates are of one piece.
